(19) United States
(12) Patent Application Publication
(10) Pub. No.: US 2014/0242223 A1
(43) Pub. Date: Aug. 28, 2014

(54) Frozen pizza preparation package and method

(71) Applicants: Michael Weinstein, West Bloomfield, MI (US); Robert E Weinstein, Farmington Hills, MI (US)

(72) Inventors: Michael Weinstein, West Bloomfield, MI (US); Robert E Weinstein, Farmington Hills, MI (US)

(21) Appl. No.: 14/183,602

(22) Filed: Feb. 19, 2014

Related U.S. Application Data
(63) Continuation-in-part of application No. 14/073,949, filed on Nov. 7, 2013.
(60) Provisional application No. 61/768,603, filed on Feb. 25, 2013.

(51) Int. Cl. A21D 13/00; A21D 8/06; A21D 15/02

(52) U.S. Cl. CPC A21D 13/007; A21D 15/02; A21D 8/06
USPC 426/87; 426/393; 426/243

(57) ABSTRACT

A frozen pizza preparation package and method includes a frozen prebaked pizza crust, pizza toppings, microwave-crisping sequence instructions that instruct sequential steps of heating the frozen prebaked pizza crust and pizza toppings in a microwave oven followed by crisping the crust using a crisping appliance, and a unifying container incorporating the frozen prebaked pizza crust, pizza toppings and the sequence instructions.

This application is a Continuation-in-Part application of U.S. application Ser. No. 14/073,949, filed on Nov. 7, 2013, which claims the benefit of U.S. Provisional Patent Application No. 61/768,603, filed Feb. 25, 2013.

### BACKGROUND OF THE INVENTION

1. Field of the Invention

The present invention relates generally to frozen pizzas. Particularly, the present invention relates to a frozen pizza devices and methods.

2. Description of the Prior Art

Pizza is a widely consumed food item in the United States. Annual pizza revenue for the year 2012 was about $32 billion, and ninety three percent of Americans eat at least one slice of pizza per month. There are about 70,000 pizzerias in the United States and 65% of them are independent firms. Pizza crusts range from thin to thick, and 61% of Americans prefer thin crust.

Despite the subjective nature of food preference and taste, there is general acceptance that pizza procured where the product is freshly prepared, such as at a pizzeria, and immediately consumed after baking, is especially desirable.

Considered less desirable than such fresh pizzas are those that are preserved by freezing, and later prepared for eating. This manner of pizza consumption may be necessitated when freshly baked pizza is not locally available or cannot be conveniently procured at the very time when pizza is desired. A number of factors contribute to making frozen pizza less desirable than fresh pizzas. Contributing to making frozen pizza less desirable than fresh pizzas, freezing imposes the need for the consumer to prepare the frozen pizza to make it consumable. The consumer is required to either bake or microwave-heat present frozen pizzas. There are major shortcomings attendant to either process. Considerable time is required for the consumer to prepare the pizza where the frozen pizza is to be baked, in some instances even exceeding the time to drive to a pizzeria or have a hot pizza delivered. In the case of preparing frozen pizza with a microwave oven, heating the pizza evenly and crisping the crust remain unsatisfactory.

There are numerous available frozen pizzas that are widely sold at supermarkets and other food outlets. Examples include: “Tony's Cheese Crispy Crust Pizza” produced by the Schwan Food Company, Bloomington, Minn.; “DiGiorno For One Traditional Crust Frozen Pepperoni Pizza” distributed by Nestle USA, Northbrook, Ill.; “Bellatora Ultra Thin Crust Pizza” prepared by Bernatello's Pizza, Inc., of Maple Lake, Minn.; “Trader Giotto's Pizza 4 Formaggi Handmade Four Cheese Pizza” distributed and sold exclusively by Trader Joe's, Moravia, Calif.; “Red Baron Classic Crust” Pepperoni Pizza distributed by Schwan's Consumer Brands, Inc, Bloomington, Minn.; “Totino's Party Pizza” distributed by General Mills Sales. Inc, Minneapolis, Minn.; “Jeno's by Totino's Pizza for One” distributed by General Mills Sales. Inc, Minneapolis, Minn.; “Sabatasso”s Pizzeria Pizza Singles, Thin Crust” distributed by Schwan's Consumer Brands, Inc. Bloomington, Minn.; and “Kirkland Signature Pepperoni Pizza, Rising Crust” distributed by Costco Wholesale Corporation, Seattle, Wash.

The aforementioned frozen pizzas are provided with instructions for consumer preparation by one, or both, of two methods: baking, or microwave heating. Frozen pizza instructions typically instruct the consumer to heat a conventional oven to between 350-450 degrees Fahrenheit, and this may take from about 20-25 minutes depending upon the particular oven and the advised temperature. Once the oven is heated, the consumer is instructed to bake the pizza at full recommended heat for a time period ranging from 7 to 25 minutes. The process of baking a frozen pizza therefore takes from about 25 to 45 minutes.

To exemplify this, the aforementioned Tony's pizza instructs heating the oven to 400° F. and cooking on a rack for 12-14 minutes. Therefore, a total preparation time of over 30 minutes is required. The aforementioned DiGiorno pizza instructs heating the oven to 450° F. and placing the pizza directly on the center rack of the oven to bake for 17-19 minutes or until the cheese is melted. Instructions for the aforementioned Red Baron Pizza are to heat the oven to 400° F. and cook the pizza for 17-19 minutes. Similarly, Kirkland Pizza instructions are to heat oven to 425° F. and bake for 22-25 minutes or until cheese is melted and edges are golden brown, where total preparation time is likely to exceed 40 minutes.

Presently available frozen pizzas that are instructed for microwave heating can be made ready for serving considerably more quickly than those instructed for baking. To illustrate this, the cooking instructions that are provided with above noted Tony's pizza instructs the consumer to microwave the pizza on high for 3.5 to 4 minutes until the center is melted. Above noted DiGiorno pizza instructs the consumer to microwave the product from 3.5-5.5 minutes according to the strength of the microwave oven: 5 minutes and 30 seconds at 600-800 watts, 4 minutes and 30 seconds at greater than 800 and up to 1100 watts, or 3 minutes and 30 seconds at greater than 1100 watts. If the cheese is not melted, the consumer is instructed to continue cooking the pizza in 30 second intervals.

While allowing a shorter preparation time compared to baking, the crust resulting from microwave heating tends to be less crisp when compared to baked pizzas, either freshly baked pizza or frozen pizzas that require baking. Rather than a chewy crust with a crisp outer layer that can result from baking, microwave thawed and heated crusts tend to be soggy, spongy, doughy, and unevenly cooked. The unsatisfactory crusts of microwave pizzas are the subject of numerous innovations that attempt to improve upon them.

U.S. Pat. No. 4,283,424 issued to Bone et al. discloses frozen pizza crust suitable for microwave cooking. Bone et al. point out that: “. . . most if not all pizza attempted to be cooked in a microwave oven have been characterized by . . . an extremely unpalatable, often soggy crust” and teach a composite crust with a first layer of cracker-type dough material with 5% or less moisture and a second baked bread dough crust having a moisture content of 20-40% where the drier layer is capable of absorbing water vapor generated in microwave cooking.

U.S. Pat. No. 6,627,242 issued to McPherson, et al. similarly points out that microwaved cereal products such as pizza crusts are generally not pleasing to the palate. McPherson et al. further state that it is difficult to generate a crisp or brown outer crust and that microwave heating is generally uneven. McPherson et al. state that it is for this reason that susceptors are often required, but even the use of susceptors can lead to uneven heating and/or uneven crisping of pizza crust. McPherson et al. teach an alternative to ordinary dough, namely a pizza crust comprising mesophase-gel, which when baked in a microwave oven rises in a manner similar to conventional baked-oven pizza crust. The resulting crust is described as having a firm texture and being palatable.

U.S. Pat. No. 5,519,195 issued to Keefer, et al. discloses the employment of susceptors, which are devices that incorporate material that absorbs microwave energy to become heated, to improve upon microwave cooking. The disclosure, however, points to disadvantages of heating a susceptor to high temperature to attempt to heat a food surface: risk of overheating, of breakdown of the material of the susceptor and even generation of toxic products, and teaches preventive modifications.

U.S. Pat. No. 6,204,492 issued to Zeng et al. discloses that food cooked in a microwave oven generally does not exhibit the texture, browning, and/or crispness that are acquired when food is cooked in a conventional oven. Zeng et al. also point to using a susceptor material that is a thin metallized film that heats with microwave energy, focusing heat on the food. The disclosure again points to hot and cold spots, potential for fire, and arcing with these devices that their invention seeks to overcome with the placement and pattern of metallic segments.

Despite such attempts to improve upon preparation of frozen pizza using a microwave oven, the present state of the art may best be reflected in the instructions provided with presently sold microwave pizzas recommending baking rather than microwave heating for best results or to achieve a crisp crust. “Tony's Pizza for One” recommends: “Microwave on high 2 minutes 30 seconds to 3 minutes 15 seconds . . . ” and “Oven instructions: (recommended for best results) pre-heat oven to 425° F. . . . ” Similarly, “Microwavable Tony's Crispy Crust Pepperoni Pizza” includes microwave instructions, but adds: “Oven Instructions for a Crisp Crust.” Kroger brand “Classic Crispy Crust 3 Minute Microwave Pizza” has instructions to microwave the pizza but also has conventional oven directions that state: “for a crisp crust, bake pizza directly on oven rack.” “Sabatasso's Pizzeria Singles Thin Crust” comes with microwave instructions and also conventional oven instructions that are: “Recommended for a crisper crust.”

The strength and distribution of microwave energy is known to vary from oven to oven, and it is acknowledged that microwave cooking is spatially uneven and that heat application may vary in accordance with placement of a foodstuff in the microwave. Non-uniform heating of frozen pizza allowing pathogen persistence has been associated with food-borne illness.

What is therefore needed is a frozen pizza that can be more quickly prepared by the consumer than present frozen pizzas instructed for baking, and that has a crust that is more akin to baked pizza, and preferably to pizzeria-type baked pizza, than to the crust of present frozen microwave pizzas after they are prepared by microwave according to their instructions.

### SUMMARY OF THE INVENTION

Present cooking methods for frozen pizza are not entirely satisfactory. Of the present methods available to consumers, baking or microwaving frozen pizza to prepare it for consumption, each has at least one significant shortcoming. Baking a frozen pizza is time consuming. Individuals may not wish to wait for the time required to bake a frozen pizza to satisfy a craving for pizza, or in some instances, may not have enough time to bake a frozen pizza. It is unwise, however, for a consumer to shortcut recommended preparation instructions, as cooking instructions provided with packaged frozen pizzas by their various manufacturers, packagers, and distributors relate to the state of preparation of the pizza before it is frozen. Present frozen pizzas often contain components that are not sufficiently cooked for consumption before the pizza has been frozen. Care to follow instructions is especially important to avoid food-borne illness when the frozen pizza contains a meat topping.

The drawback of frozen pizzas that consumers reheat by microwave is that the resulting crusts lack the texture and crispness of baked pizzas. In the instance where the frozen pizza is thawed and heated in a microwave oven, the resulting crust is generally not as crispy or evenly cooked as when a pizza is baked. The microwave adaptations and methods described above also have shortcomings. For example, the provision of a portion of crust with a cracker layer to imitate the crispness of ordinary baked pizza cannot be expected to result in a crust having the same texture and crispness of conventional baked pizza, but rather to result in a cracker-like imitation, and the use of chemical additives to emulate natural foods is undesirable.

The present invention solves these problems by providing a frozen pizza preparation package and method that allows for rapid preparation of frozen pizza compared to baking and achieves a more evenly heated pizza with a crisp pizza crust compared to microwave pizzas that are presently available to an ordinary consumer, that is, one who is not expert in the art of pizza preparation or pizza baking.

It is an object of the present invention to provide a frozen pizza product that can be quickly and conveniently prepared by a consumer, preferably in less than five minutes to quickly satisfy a craving for pizza, and that has a crisp and evenly heated crust after preparation.

It is another objective to enable a consumer to quickly prepare a frozen pizza that is more closely akin to a pizzeria-type pizza (that one might procure at a pizzeria) than has been heretofore possible.

It is a further object of the present invention to provide a consumer with a frozen pizza preparation package and teach a method that allows a consumer convenient and rapid preparation of such a pizza.

It is a preferred object of the present invention to provide a consumer with a pizza crust that has been prebaked, and with pizza toppings layered thereupon after baking of the crust, where the prebaked crust and toppings are then frozen, and with instructions that allow the consumer to rapidly, conveniently, and safely prepare a pizza by microwave thawing and heating of the pizza crust and toppings, followed by crisping of the crust bottom.

The present invention achieves these and other objectives by providing a pizza rapid preparation package. The pizza rapid preparation package includes a frozen prebaked pizza crust, frozen toppings, and instructions to rapidly prepare a pizza with a crispy crust by microwave thawing and heating of the pizza crust and toppings followed by crisping of the crust bottom. In preferred embodiments, the toppings are layered upon the prebaked pizza crust by the manufacturer, and in alternative embodiments, the crust and toppings are separately provided, requiring the consumer to layer the toppings upon the crust.

The term “fresh pizza” means a pizza that has not been frozen.

The term “pizzeria-type pizza” means a pizza that is made and sold at pizzerias and consumed hot from the oven or delivered, having a crisp crust that is either thin or thick, but preferably thin.

The terms “topping, toppings or pizza toppings” means any of sauces (for example, tomato sauce), cheeses (examples being mozzerella and parmesan), meats (examples being pepperoni, bacon, hamburger, and sausage), vegetables (examples being onions, mushrooms, and peppers), and other food ingredients, alone or in combination that are known in the art to be layered upon a pizza crust.

The term “prebaked pizza crust” is herein intended to mean a pizza crust that is sufficiently baked as to be suitable to eat prior to its being frozen.

The term “frozen prebaked pizza crust” is herein to mean and is used to refer to a prebaked pizza crust that is then frozen.

The term “prebaked frozen pizza” is herein intended to mean a pizza crust with topping(s) thereon that is baked together and then frozen, as has been previously considered in U.S. application Ser. No. 14/073,949. “Prebaked frozen pizza” differs from the “prebaked pizza crust” and “toppings” considered in the present invention, where crust and toppings are not baked together prior to being frozen.

The terms “thin crust pizza” and “thick crust pizza” has those meanings as ordinarily understood by consumers of pizza and by one of ordinary skill in the art of pizza making.

In preferred embodiments of the present invention, the frozen pizza preparation package includes a prebaked pizza crust and toppings layered upon the prebaked crust, both frozen together as a pizza, and microwave-crisping sequence instructions. In alternative embodiments of the present invention, the frozen pizza preparation package includes a prebaked pizza crust and toppings, where each is provided separately, and microwave-crisping sequence instructions. The microwave-crisping sequence instructions include a heating step employing a microwave oven, followed by a crisping step employing a crisping appliance. One example of a crisping appliance includes, but is not limited to, a stovetop skillet or pan to crisp the bottom of the crust of the microwave-heated pizza (the side not covered with toppings) on a stovetop.

In preferred embodiments, the package contains a transfer substrate that affords the consumer means to safely transfer the pizza between heating and crisping devices and avoid touching heated surfaces.

In most preferred embodiments of the present invention, the frozen pizza preparation package includes a frozen prebaked pizza crust, frozen toppings, a transfer substrate, and microwave-crisping sequence instructions. The microwave-crisping sequence instructions in this instance prescribes a heating step employing a microwave oven followed by a crisping step, and the employment of the transfer substrate to move the hot microwave-heated pizza from the microwave oven to the crisping appliance.

As described in the prior application of Weinstein (U.S. application Ser. No. 14/073,949), which is incorporated herein by reference, it was found that a microwave step was essential to thaw and heat a prebaked frozen pizza sample as rapidly as was desired. Attempts to alternatively employ stovetop heating to thaw and heat pizza from a frozen state resulted in requiring far more time and in burning the bottom of the pizza crust before sufficiently heating the toppings.

As was found with frozen prebaked pizza (where both crust and toppings were baked together prior to freezing), it is now concordantly found that microwave heating of frozen prebaked pizza crust layered with frozen toppings weighing approximately 80 grams in all in a 1000 watt output microwave oven for less than one minute (i.e. about 40 seconds) sufficiently reheats the crust and frozen toppings that include tomato sauce and pepperoni, and melts the cheese. The same is found for heating approximately 200-300 grams of the same frozen prebaked pizza crust and toppings for about two minutes using the same oven. It is anticipated that larger pizza components such as more voluminous toppings or a thick crust, yet sized to fit into a microwave oven, and/or the use of a less powerful microwave oven, would require proportionally more time, but not exceeding about 7 minutes.

As has been previously described in U.S. application Ser. No. 14/073,949 with frozen prebaked pizza, the crust resulting from microwave heating of frozen pizza was not satisfactorily crisp, and clearly not as crisp as the crust of a pizza prepared by baking. Lifting the edge of tested microwave heated pizzas caused the pizza to sag, due to their being soggy and insufficiently crisp. Further, such pizzas were found to be less evenly reheated than desired, some areas being hotter than others even if on a rotating tray in the microwave oven and also turned to two different positions in the oven during heating. Requiring a consumer to change the position of the pizza more than this would not be practicable. The same outcome is now found when microwave heating frozen prebaked pizza crust that is layered with frozen toppings: the crust is not as crisp as desired; not as crisp as a frozen pizza crust that has been thawed and heated by baking, sagging occurs when lifting the pizza edge; and the crust and toppings are found to be unevenly heated.

As previously described in U.S. application Ser. No. 14/073,949 with frozen prebaked pizza, an additional step of, heating microwaved pizza on an open stovetop pan at high heat was found to reproducibly result in more even cooking of the pizza crust and toppings and to achieve sought-after crust crispiness. Further, a surprisingly short period of open skillet heating was found to produce the desired outcome: about 30-90 seconds for a thin crust pizza weighing from about 75-300 grams. The same outcome is now found for heating frozen prebaked pizza crust that is layered with toppings. It is anticipated that crisping larger pizza crusts and toppings where there is a thick crust, or crisping at lower heat might require more time, but not more than about 3 minutes.

As also disclosed in U.S. application Ser. No. 14/073,949, it was expected that subjecting a microwave reheated frozen pizza to high direct skillet heat would cause the crust to burn as quickly as might occur when ordinarily baking fresh pizza, and that there would be little leeway between crisping the crust and burning it. In contrast to expectation, stovetop heating at high heat could be surprisingly continued for a period past when the crust was sufficiently crisped without the crust burning. We have hypothesized that the vaporization of water in the crust during the preceding microwave step, while producing undesirable sogginess, also serves a protective function that prevents the crust from burning during the subsequent step of pan crisping. Regardless of the reason, the unexpected latitude for crisping a microwave-reheated, prebaked frozen pizza on a stovetop pan or skillet without burning it, even though the crust had been previously baked, suggested a reliable preparation method for lay individuals and commercial viability. The same observations are now considered to apply to the preparation of the combined components of the present invention, namely frozen prebaked pizza crust layered with frozen toppings.

In preferred embodiments, the present invention contains means to safely transfer hot microwave heated pizza (that is, frozen prebaked pizza crust and layered frozen toppings that have been microwave heated) between heating and crisping devices to avoid touching heated surfaces.

To simplify transfer of hot pizza between two heating modalities, an optional transfer device such as a planar transfer substrate was devised to avoid the potential for touching hot pizza or another hot surface.

Hence, in embodiments of the present invention, the frozen pizza preparation package includes a prebaked frozen pizza crust and frozen toppings that are either layered upon the crust or separate, a transfer substrate, and microwave-crisping sequence instructions. The microwave-crisping sequence instructions prescribes a heating step to heat the frozen prebaked crust and frozen toppings that are layered upon the crust employing a microwave oven followed by a crisping step, and the employment of the transfer substrate to remove the microwave-heated pizza from the microwave oven to the crisping appliance.

The transfer substrate is preferably configured so it can be situated under the frozen prebaked pizza crust layered with frozen toppings before and during the microwave-heating step such that it can convey the just-heated pizza from the microwave oven to a crisping device that is a stovetop skillet heated on an ordinary stove top, or alternatively, a toaster oven without touching a hot surface. The crisping device has preferably been heated prior to its being needed, most conveniently when the pizza is being heated in the microwave oven. When the crisping step is finished, the pizza can be transferred back to the transfer substrate from which the pizza can be eaten. The pizza can instead be served on an ordinary plate. In the case of using a skillet, the pizza can be slid from the skillet onto the plate. When using a toaster oven the pizza can be transferred to a plate using the transfer substrate. Where there may have been concern about difficulty or inconvenience with a two-staged frozen pizza cooking method, it has been found that the sequence of microwave heating and crisping is uncomplicated, can be facilitated by a transfer substrate, and that the method is desirable in providing the immediate reward of a heated pizza with a crispy crust within a very few minutes.

It is contemplated that the transfer substrate need not be elaborate in design. It is preferably constructed of microwave-compatible material to allow it to be microwaved with the pizza crust and layered toppings and essential that it be configured for removing the pizza from the microwave oven and for positioning the pizza into the crisping device. Suitable materials that might be employed for the transfer substrate include paper, glass, suitable metals, plastic, or a combination of these. The incorporation of susceptor foils, while appearing unnecessary, is not precluded. Various grasping means by which the transfer apparatus can be securely grasped by a consumer to transfer the pizza without touching a hot surface are also contemplated. Alternative transfer substrate configurations that would allow the consumer to transfer the pizza without touching a hot surface are considered within the scope of the invention, including transfer substrate devices that are not situated with the pizza during microwave heating.

In a further embodiment of the present invention, the transfer substrate has a grasping adaption selected from the group consisting of at least one tab extending co-planar from a peripheral edge, a handle extending above the transfer substrate, an elongated tab pivotally connected adjacent a peripheral edge of the transfer substrate where the elongated tab pivots between a stored position and a grasping position, and a transverse side extending from the peripheral edge of the transfer substrate.

In still another embodiment of the present invention, the transfer substrate incorporates a material selected from the group consisting of plastic, paper, various metals including foil-coated paper, cardboard, glass, and combinations thereof.

Preferred embodiments of the present invention are those in which the prebaked pizza crust and pizza toppings are layered together by the manufacturer and then frozen by the manufacturer to comprise a frozen pizza. Alternately, embodiments include those in which the prebaked pizza crust and toppings are frozen separately such that the consumer is required to layer the toppings upon the crust. In this instance, the frozen toppings are preferably provided by the manufacturer to be commensurate with the size and shape of the pizza crust to allow the toppings to be easily layered by the consumer.

In yet another embodiment of the present invention, the frozen pizza package includes a container that unifies the frozen prebaked pizza crust, the frozen toppings, the transfer substrate, and the instructions.

In another embodiment of the present invention, there is disclosed a method that involves microwaving a prebaked frozen pizza crust layered with frozen toppings for a predefined time, transferring the microwaved pizza to a device for crisping the crust of the pizza, and crisping the crust of the pizza. The crisping step may be performed using a stovetop pan/skillet on a stovetop, or a toaster over.

In still another embodiment of the present invention, there is disclosed a method of making a frozen pizza preparation package usable by a consumer that includes (a) prebaking a pizza crust for a sufficient time wherein the pizza crust is suitable for consumption, (b) performing pizza assembly steps selected from the group consisting of (1) placing toppings upon the pizza crust and freezing the pizza crust and toppings, and (2) freezing the pizza crust, preparing pizza toppings and freezing the toppings, and devising instructions for a consumer to layer the toppings upon the pizza crust, (c) devising microwave-crisping sequence instructions that instruct sequential steps of heating the frozen pizza in a microwave oven followed by crisping the pizza crust with a crisping appliance, (d) devising a unifying container, and (e) incorporating the frozen prebaked pizza crust, toppings, and the sequence instructions together in the unifying container.

In a further embodiment of the present invention, there is described a method for rapidly preparing frozen pizza for consumption that includes (a) obtaining a frozen pizza preparation package that is a container having (1) a frozen prebaked pizza crust, (2) a pizza topping component having one or more toppings, (3) layering instructions for a consumer to layer the pizza topping component upon the frozen prebaked pizza crust, and (4) microwave-crisping sequence instructions that instruct positioning the frozen prebaked pizza crust with topping thereon upon a transfer substrate and into a microwave oven, heating the pizza, and using the transfer substrate to transfer the microwave-heated pizza to a crisping appliance, and using the crisping appliance to crisp the crust, and (b) following the layering instructions and microwave-crisping sequence instructions.

### BRIEF DESCRIPTION OF THE DRAWINGS

FIG. 1 is a perspective view of one embodiment of the present invention showing a frozen pizza preparation package.

FIG. 2 is a perspective view of one embodiment of the frozen pizza of FIG. 1 showing a frozen prebaked pizza crust that has a layer of frozen pizza topping.

FIG. 2A is a cross-sectional view of the frozen pizza with topping showing a peripheral crust edge.

FIG. 2B is a perspective view of an embodiment comprising a frozen prebaked pizza crust, frozen toppings that conform to the shape of the pizza crust, and frozen toppings layered upon the frozen prebaked pizza crust.

FIG. 3 is a perspective view of the present invention showing one embodiment of the transfer substrate with at least one tab extending from the periphery of the transfer substrate as the grasping adaptation.

FIG. 4 is a perspective view of the present invention showing another embodiment of the transfer substrate with a handle extending from the periphery of the transfer substrate above and across the transfer substrate.

FIG. 5 is a perspective view of the present invention showing another embodiment of the transfer substrate with a pivotable, elongated tab pivotally connected adjacent the periphery of the transfer substrate as the grasping adaptation.

FIG. 6 is a top view of the transfer substrate in FIG. 5 showing the elongate tab in a stored position.

FIG. 7 is a top view of the transfer substrate in FIG. 5 showing the elongate tab in a grasping position.

FIG. 8 is a perspective view of another embodiment of the transfer substrate showing transverse sides and an open side.

FIG. 9 is a perspective view of one embodiment of the container of the present invention showing the instructions on a top surface.

FIG. 10 is a schematic illustration of a preparation step of the present invention showing the prebaked frozen prebaked pizza crust with frozen toppings thereupon ready for being placed in a microwave oven.

FIG. 11 is a schematic illustration of a step of the present invention showing the microwaved pizza being transferred utilizing a transfer substrate to a stovetop pan for crisping.

FIG. 12 is schematic illustration of a step of the present invention showing the crisped pizza being placed back onto the transfer substrate.

FIG. 13 is a schematic illustration of a preparation step of the present invention showing the prebaked frozen pizza crust with frozen toppings thereupon being placed in a microwave oven.

FIG. 14 is a schematic illustration of a step of the present invention showing the microwaved pizza being transferred utilizing a transfer substrate to a toaster over for crisping.

### DETAILED DESCRIPTION OF THE PREFERRED EMBODIMENT

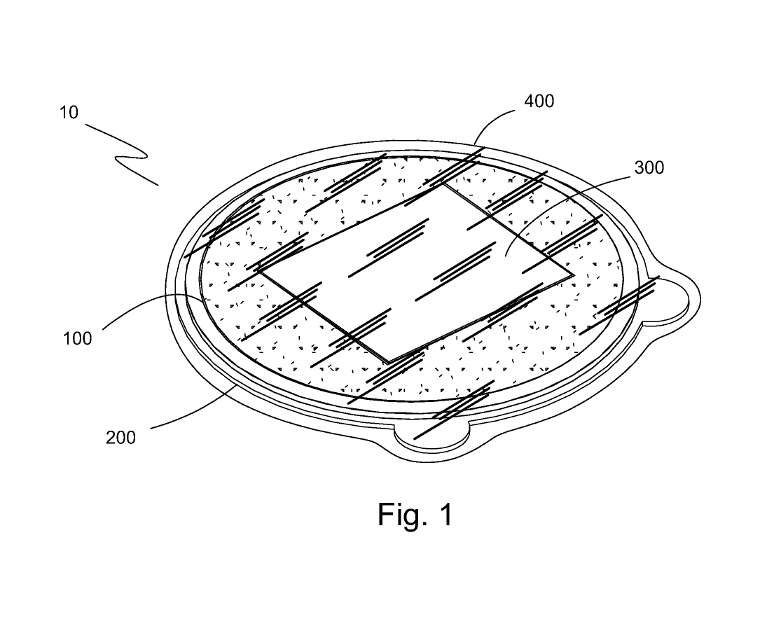

The preferred embodiments of the present invention are illustrated in FIGS. 1-14. FIG. 1 shows one embodiment of a frozen pizza preparation package 10 of the present invention. Frozen pizza preparation package 10 includes a prebaked frozen pizza crust with frozen toppings layered thereon 100, a transfer substrate 200, microwave-crisping sequence instructions 300, and a unifying container or wrap 400. Package 10 preferably has a surface upon which the sequence instructions 300 are displayed. It is contemplated that sequence instructions can alternatively be unified in the package, for example, on a separate sheet within the package.

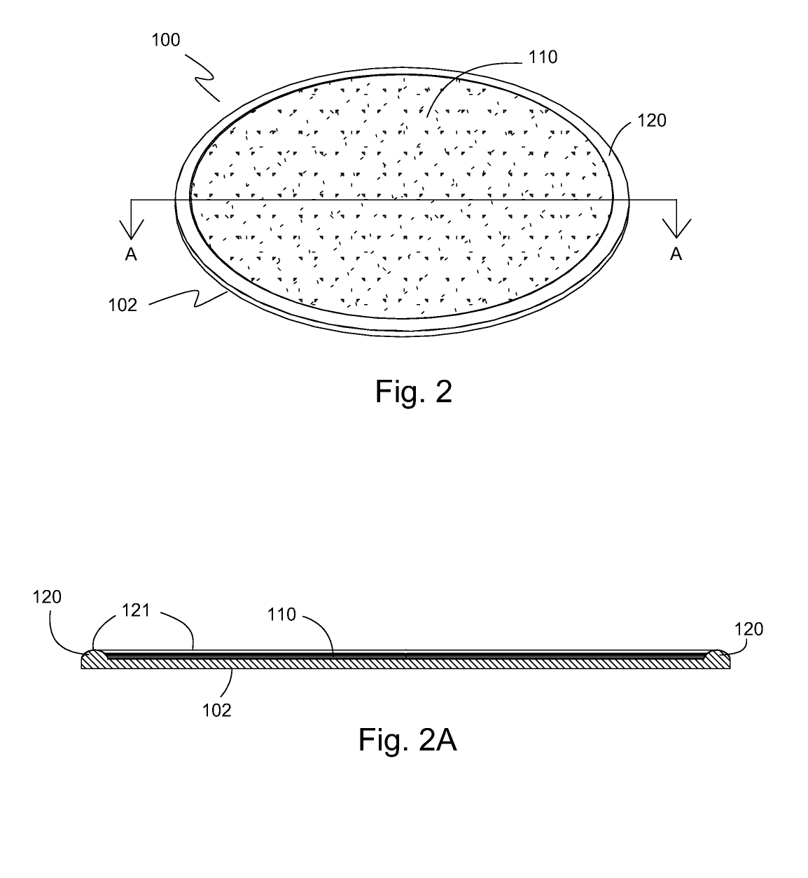

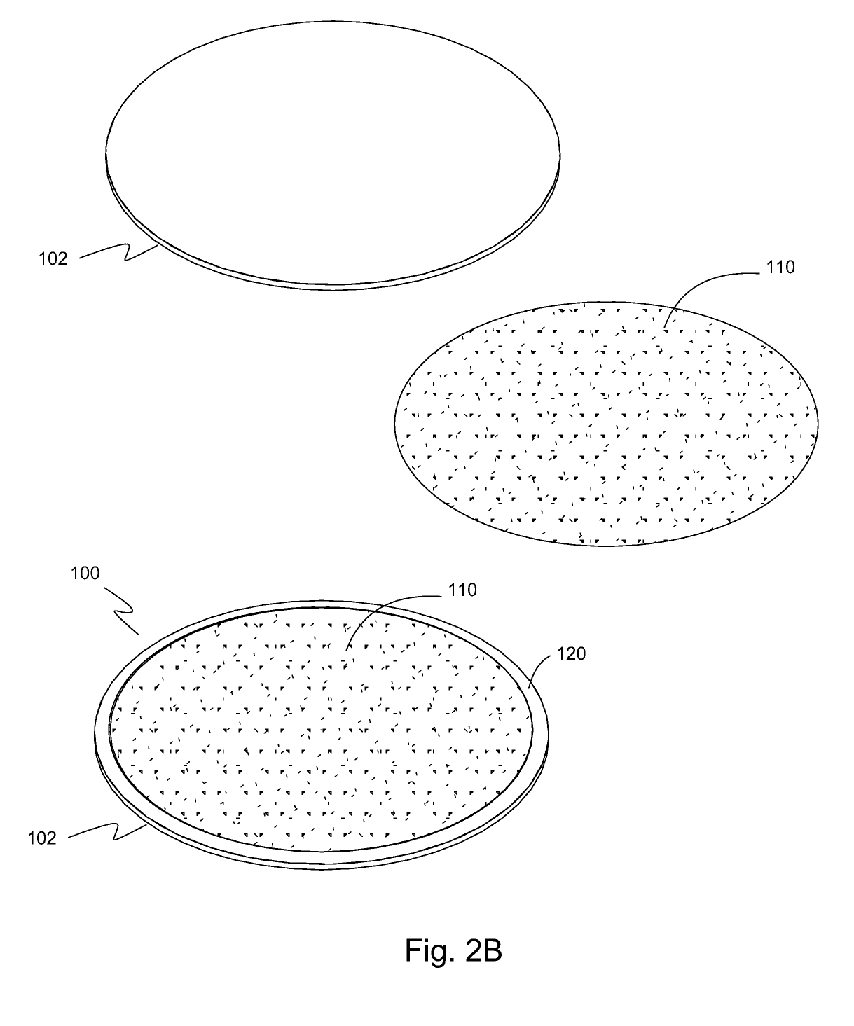

Turning now to FIGS. 2 and 2A, frozen pizza 100 includes a pizza crust 102 made of dough known in the art as pizza dough and that is a frozen prebaked pizza crust, at least one frozen topping 110 disposed over a major portion of the pizza crust 102 and a peripheral crust border 120. As more clearly shown in FIG. 2A, peripheral crust border 120 preferably has a peripheral crust top 121 that is approximately ⅛″ or greater in its outermost dimension than topping 110, such that the toppings do not run over the crust during heating. Pizza body 102 typically has a disc shape but may also be square, rectangular, or other shape, or irregular, and is not limited to a circular shape. The pizza may be of any size, but preferred sizes are portions that are suitable for one or two individual servings and that might easily fit into an ordinary microwave oven or skillet, therefore about 6″ to 14″ in largest dimension. Thin crust pizzas of such dimension weigh about 100 to 500 grams and most optimally about 160 to 320 grams. It is further considered that a mini-pizza as small as 50 grams might be an alternative.

Frozen pizza 100 incorporates a prebaked crust. Prebaking the pizza crust before freezing allows the manufacturer to control how the crust is prepared and baked before it is frozen, according to the manufacturer's preference. Significantly, prebaked pizza crust provides the quickest path from freezer to plate, where the intent of the present invention is to provide a quickly prepared pizza, and not require time to bake an unbaked, relatively unbaked or raw pizza crust.

FIG. 2B illustrates an embodiment of the frozen prebaked pizza crust 102 and frozen toppings 110 of the present invention where the crust and toppings are similarly configured such that the consumer, or preferably the manufacturer, can layer conforming toppings upon the crust. Both crust 102 and toppings 110 are illustrated as round, however other shapes are anticipated. Preferably, the toppings 110 are proportioned to leave a border 120 of crust alone at the periphery of the assembled pizza 100 when the toppings 110 are applied.

The application of bulk, unshaped toppings upon pizza crust by automated or semi-automated mechanical means is well known in the art of frozen pizza production, and commonly performed by pizza manufacturers. Such application of toppings to a prebaked crust of the present invention to result in a pizza that can then be frozen by the manufacturer is considered within the realm of the present invention. It is preferred that such application result in a border of crust alone.

Additionally, the provision of toppings to a consumer in bottles, jars, packets and other food packaging as is commonly known, where the toppings do not correspond to the shape of the prebaked crust, yet can be applied to the prebaked crust by the consumer is anticipated, for example, such that the consumer can sprinkle or place discrete portions of frozen toppings on the crust, or thaw the toppings and pour them onto the crust.

Regardless of the form of toppings, it is understood that the toppings are sufficiently prepared prior to freezing as to be safe and palatable for consumption after microwave heating alone, as instructed by the package.

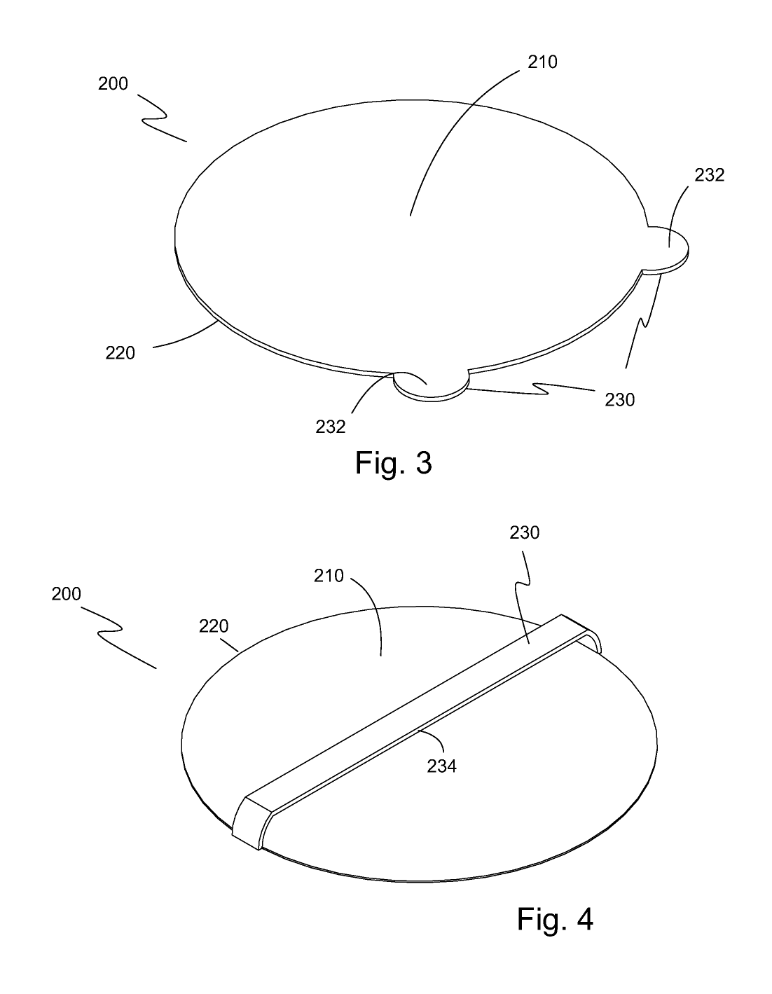

Turning now to FIG. 3, there is illustrated one embodiment of the transfer substrate 200 of various embodiments of the present invention. Transfer substrate 200 has a substrate body 210, a rounded peripheral edge 220, and a grasping adaptation 230. Substrate body 210 supports frozen prebaked pizza crust 102 and layered frozen toppings 110 during the microwaving process. In this embodiment, grasping adaptation 230 is one or more tabs 232 that extend away from peripheral edge 200 and co-planar with substrate body 210. Tab 232 allows a consumer to grasp transfer substrate 200 in an area that would not cause the consumer's hand to be in direct contact with the hot pizza after it is heated in the microwave oven. The rounded peripheral edge 220 of this embodiment is illustrated to conform to the shape of a rounded pizza, and in this case, also conform to the shape of a rounded stovetop pan. It is preferred for the transfer-edge of transfer substrates of the present invention to be in essentially the same two dimensional plane as the pizza when it sits upon the transfer substrate, as to allow the pizza to be easily slid from the transfer substrate onto a stovetop pan or placed in or out of a toaster oven.

FIG. 4 exemplifies another embodiment of the transfer substrate 200 of the present invention. In this embodiment transfer substrate 200 has a substrate body 210, a rounded peripheral edge 220 and a superiorly situated grasping adaptation 230. In this embodiment, grasping adaptation 230 is in the form of a handle 234 that is situated above substrate body 210 where a frozen prebaked pizza crust 102 and frozen toppings 110 would be supported. Handle 234 is connected to the peripheral edge 220 of transfer substrate 200, yet there is an adequate transfer-edge edge 220 for a just-microwaved pizza to be slid off the transfer substrate to a crisping device.

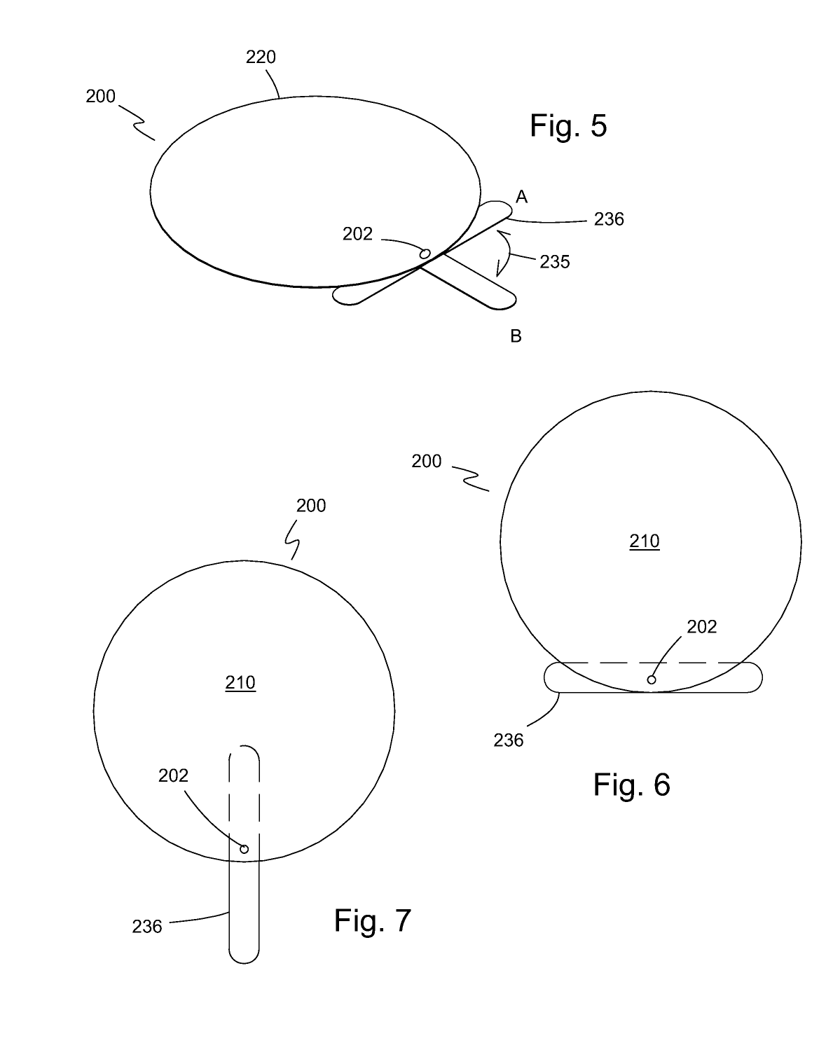

FIGS. 5, 6 and 7 illustrate yet another embodiment of transfer substrate 200. In this embodiment transfer substrate 200 has a substrate body 210, a rounded peripheral transfer edge 220 and a pivotally-connected grasping adaptation 230. As seen in FIG. 5, pivotally-connected grasping adaptation 230 is in the form of an elongated tab 236 that is pivotally connected to substrate body 210 adjacent peripheral edge 220 at pivot 202. Elongated tab 236 pivots from a stored position A to a grasping position B as indicated by arrow 235. Although elongated tab 236 is illustrated as being pivotally connected to substrate body 210 at approximately the center of elongated tab 236, it is contemplated that the pivot point of elongated tab 236 may be in any position longitudinally along elongated tab 236. FIG. 6 illustrates elongated tab 236 in stored position A where elongated tab 236 can be mostly on the underside of the transfer substrate 200 during microwaving and pivoted for grasping by the consumer to transfer the pizza. FIG. 7 illustrates elongated tab 236 in grasping position B. In grasping position B, elongated tab 236 serves as a handle for the consumer to grab when transferring the frozen pizza 100 from unifying container or wrap 400 into the microwave oven and from the microwave oven to a crisping device.

In the alternative, elongated tab 236 may be configured on the underside of a transfer substrate 200 to retract or extend on a track or support flanges (not shown).

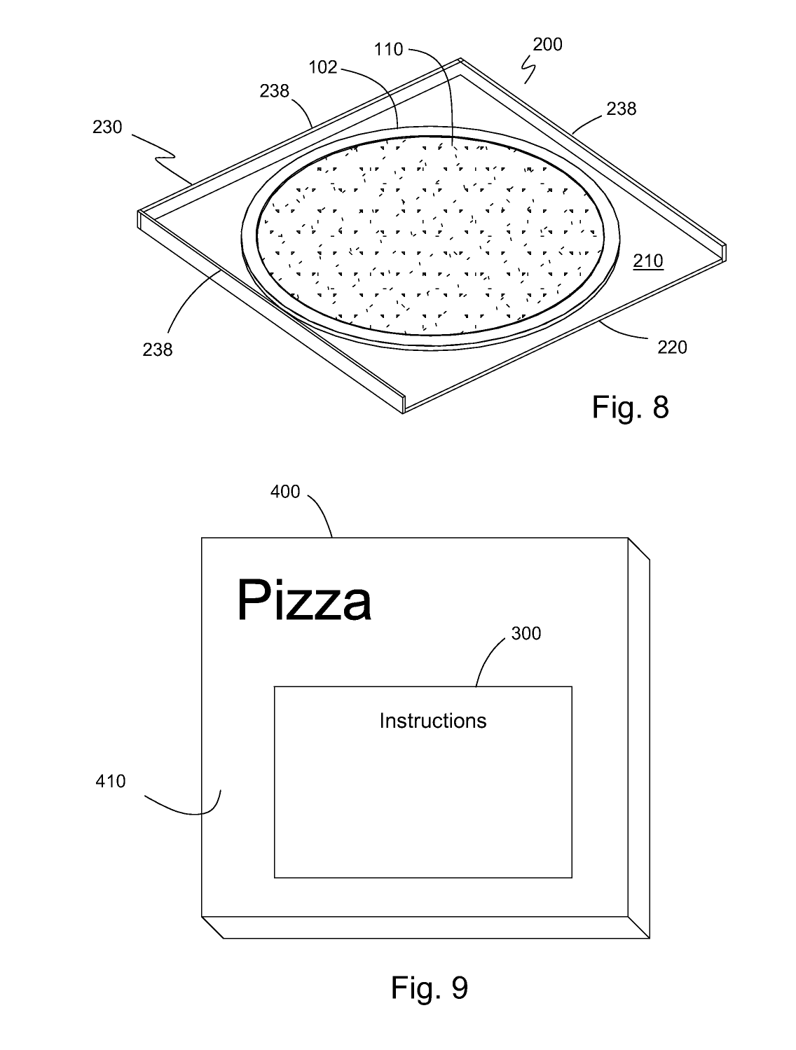

Turning now to FIG. 8, there is illustrated another embodiment of transfer substrate 200. In this embodiment, transfer substrate 200 is shown supporting frozen prebaked pizza crust 102 and frozen toppings 110 where the shape of transfer substrate 200 is square. Grasping adaption 230 is in the form of transverse sides 238 extending from peripheral edge 220 of substrate body 210. Transverse sides 238 extend upwardly from three of the four peripheral edges 220 of substrate body 210. The open edge results in a surface in essentially the same plane as the illustrated pizza, where the transfer edge would not contain the pizza, but rather allow the pizza to be readily slid from the transfer substrate 200 to a crisping appliance such as a stovetop pan or toaster oven. It is contemplated that additional sides or portions of sides might be alternatively configured to enlarge a transfer edge if desired. The present invention anticipates other transfer substrate adaptations to transfer hot pizza between heating modalities, such as grasping, tong, spatula-like or pincer-like configurations to grasp the pizza, as being within the scope of the present invention.

FIG. 9 illustrates another embodiment of container 400. Container 400 has a surface 410 that contains microwave-crisping sequence instructions 300. For example, container 400 may be a conventional pizza box. The microwave-crisping sequence instructions describe the steps for sequentially microwave heating frozen prebaked pizza crust 102 and toppings 110 in a microwave oven and then crisping the microwaved pizza in either a stovetop pan or in a toaster oven. It is noted that a frozen prebaked pizza crust, toppings and instructions containing the sequential microwave heating step and crisping step for a consumer to prepare the frozen prebaked pizza crust and toppings prior to eating are critical features of the present invention. Container 400 serves to unify instructions 300 with frozen prebaked pizza crust 102 and frozen toppings 110 and, when incorporated, transfer substrate 200.

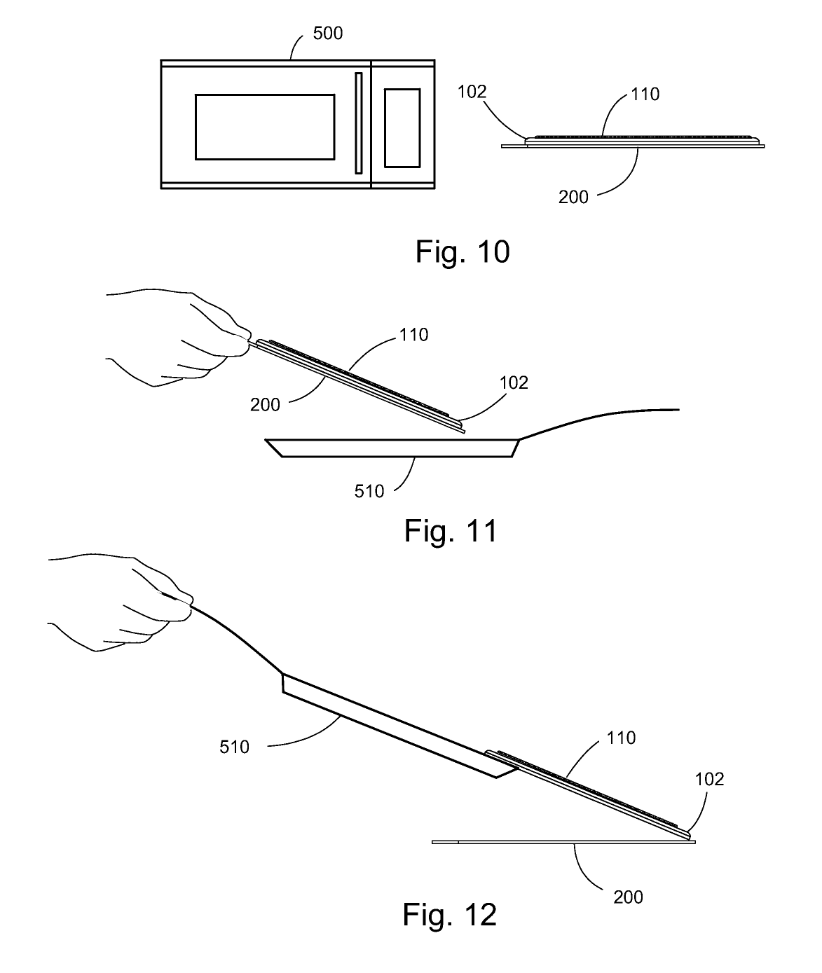

FIGS. 10, 11 and 12 schematically exemplify instructions of preferred embodiments of the present invention, which are preferably both illustrated and written. FIG. 10 illustrates a step of using a microwave oven 500 to cook a frozen prebaked pizza crust 102 with layered frozen topping 110 thereupon (side view) that is supported by transfer apparatus 200. Although not shown, it is understood that a consumer positions frozen prebaked pizza crust 102 with layered frozen topping 110 upon the transfer substrate 200 into microwave oven 500 for cooking/heating for a predefined time period. FIG. 11 illustrates a second step of sliding the microwave-heated pizza 100 onto a stovetop pan 510 using transfer substrate 200. It is understood that stovetop pan 510 is heated on a stovetop to perform the crisping step. FIG. 12 illustrates sliding the crisped pizza 100 from the stovetop pan 510 back onto the transfer substrate 200 from which it can be eaten, or the pizza 100 might be slid from the pan 510 onto an ordinary plate, as preferred.

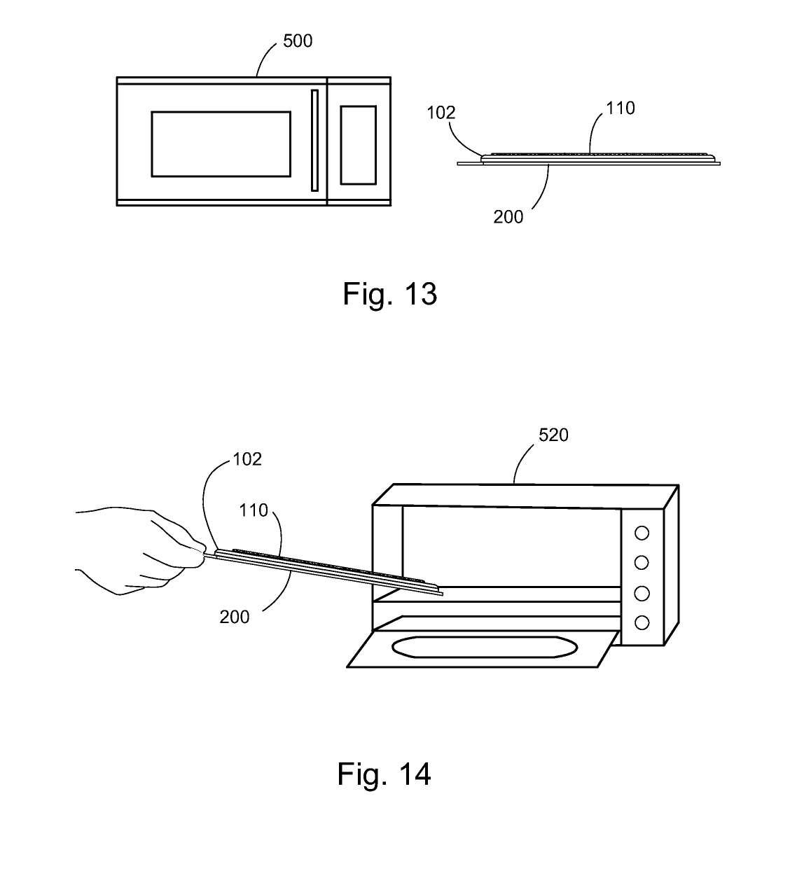

FIGS. 13 and 14 schematically exemplify instructions for toaster-oven crisping as an alternative to stovetop crisping. FIG. 13 illustrates a step of using a microwave oven 500 to heat a frozen prebaked pizza crust 102 with layered frozen topping 110 that is sitting upon a transfer substrate 200. As previously described, it is understood that a consumer places frozen prebaked pizza crust 102 and layered toppings 110 and transfer substrate 200 into microwave oven 500 for cooking/heating for a predefined time period. FIG. 14 illustrates a second step of sliding the microwave-heated pizza 100 into a toaster oven 520 using the transfer substrate 200. It is preferred that the oven be sufficiently heated so as to be ready to accept the pizza when the microwave step is completed. It is found that this might require more time compared to stovetop crisping where the skillet can be heated more quickly. The time to heat either a stovetop pan 510 or a toaster oven 520 is contemplated to vary with the kitchen appliances employed, but in either case, it is less than the time required to heat a residential kitchen oven to baking temperature. Eight (8) ounce samples of microwave-reheated frozen prebaked pizza crust 102 with layered topping 110 were adequately crisped in a toaster oven at temperatures of 400° F. for one to two minutes. The pizza crusts produced with toaster-oven crisping were found to be somewhat drier than with pizzas subjected to stovetop crisping. It is contemplated for instructions of embodiments of the present invention to instruct stovetop crisping step and/or toaster-oven crisping. When using a toaster oven 520 rather than a stovetop pan 510 for crisping, the transfer edge of transfer substrate 200 is preferably structured to allow the transfer substrate 200 to be slid under the pizza 100 to remove it from the toaster oven 520.

Adaptations to avoid sticking of the frozen prebaked pizza crust 102 with layered topping 110 to various surfaces such as the transfer substrate 200 as it is microwave heated are also considered. It is contemplated that a pizza 100 of the present invention that is fashioned with crust alone at its outermost periphery is preferable to one that has toppings at its periphery that might melt onto the transfer substrate 200 when the frozen prebaked pizza crust 102 with layered frozen topping 110 is microwaved. In such a case, it is contemplated that the melting of the toppings onto transfer substrate 200 will cause the pizza 100 to be more difficult to slide from the transfer substrate 200 onto the stovetop pan 510 or toaster oven 520. It is further considered that adding a layer of corn meal, semolina, or other non-stick material, as may be employed in pizzeria baking, to the bottom of the frozen prebaked pizza crust 102 of the present invention before it is frozen, might be optionally helpful to facilitate sliding the pizza 100 from the transfer substrate 200 or other surfaces. With regard to stovetop crisping, it has been observed that the microwave heated pizza 100 does not stick to a conventional non-stick pan when the pizza 100 was crisped at full heat for a short period of time (under two minutes), and that it was concluded not necessary to prepare the pan with oil or other entity to prevent sticking in this instance.

It is contemplated that the elements of preferred embodiments of the present invention: a frozen prebaked pizza crust 102 with frozen topping(s) 110 thereupon; a transfer substrate 200; microwave-crisping sequence instructions 300 that instruct a microwave heating step and a crisping step, are incorporated together with a unifying container 400 where the container has a surface 410 that displays instructions for sequential microwave heating followed by crisping of the a frozen prebaked pizza crust 102 with frozen topping(s) 110 thereupon. Preferred embodiments of the present invention include a transfer substrate 200; and include instructions that instruct utilizing the transfer substrate 200 to transfer heated pizza from the microwave oven to a crisping device.

The present invention teaches devices and methods to provide a consumer with a frozen pizza package, where a pizza can be more quickly prepared than frozen pizzas that require baking, and where more crispy and evenly heated crust is achieved in comparison to microwave-prepared frozen pizzas. The invention allows the consumer to accomplish this without special apparatus, but rather with ordinary kitchen devices.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A frozen pizza rapid preparation package comprising:
a frozen prebaked pizza crust and at least one topping;
microwave-crisping sequence instructions that instruct sequential steps of heating the prebaked frozen pizza crust and at least one topping in a microwave oven followed by crisping the crust using a crisping appliance; and
a unifying container incorporating the prebaked frozen pizza crust and at least one topping and the microwave-crisping sequence instructions.

2. The package of claim 1 wherein the prebaked frozen pizza crust and at least one topping comprises a thin crust pizza.

3. The package of claim 1 wherein the prebaked frozen pizza crust and at least one topping has a characteristic selected from the group consisting of a weight in the range of about 50 to 500 grams, a weight in the range of about 160 to about 320 grams, a largest dimension that measures in the range of about 6 to about 14 inches, and a crust periphery without toppings that is about ⅛ inches or greater.

4. The package of claim 1 wherein the instructed time for microwave heating is selected from the group consisting of a range of about 40 seconds to about 7 minutes and a range of about 1.5 to 3 minutes.

5. The package of claim 1 wherein the crisping appliance is selected from the group consisting of a stovetop pan on a stovetop and a toaster oven.

6. The package of claim 5 wherein the instructed time for stovetop crisping is selected from the group consisting of a range of about 30 seconds to about 3 minutes and a range of about 30 seconds to about 90 seconds.

7. The package of claim 1 further comprising a transfer device selected from the group consisting of a planar transfer substrate and a pizza pincer adaptation wherein the microwave-crisping instructions includes instructing the use of the transfer device to transfer the microwave heated pizza from the microwave oven to the crisping appliance.

8. The package of claim 7 wherein the planar transfer substrate incorporates a grasping adaptation selected from the group consisting of at least one tab extending co-planar from a peripheral edge, a handle extending above the transfer substrate, an elongated tab pivotally connected adjacent a peripheral edge of the transfer substrate where the elongated tab pivots between a stored position and a grasping position, and a transverse side extending from a portion of the peripheral edge of the planar transfer substrate.

9. The package of claim 7 wherein the planar transfer substrate incorporates a material selected from the group consisting of plastic, paper, foil-coated paper, and combinations thereof.

10. The package of claim 1 wherein the container has a surface that contains the instructions.

11. A method of making a frozen pizza preparation package usable by a consumer, the method comprising:
prebaking a pizza crust for a sufficient time wherein the pizza crust is suitable for consumption;
performing pizza assembly steps selected from the group consisting of (1) placing toppings upon the pizza crust and freezing the pizza crust and toppings, and (2) freezing the pizza crust, preparing pizza toppings and freezing the toppings, and devising instructions for a consumer to layer the toppings upon the pizza crust;
devising microwave-crisping sequence instructions that instruct sequential steps of heating the frozen pizza crust with toppings thereupon in a microwave oven followed by crisping the pizza crust with a crisping appliance;
devising a unifying container; and
incorporating the frozen prebaked pizza crust, toppings, and the sequence instructions together in the unifying container.

12. The method of claim 11 wherein the making step includes one of the steps selected from the group consisting of (1) making the pizza crust a thin crust pizza crust, (2) making a pizza crust and toppings that together weigh about 50 to about 500 grams, (3) making a pizza crust and toppings that together weigh about 160 to about 320 grams, and (4) making a pizza crust with a largest dimension that measures in the range of about 6 to about 14 inches.

13. The method of claim 11 wherein the devising microwave-crisping sequence instructions includes microwave heating instructions selected from the group consisting of heating the frozen pizza crust with toppings for a time period in the range of 1 minute to about 7 minutes and heating the frozen pizza crust with toppings for a time period in the range of about 90 seconds to 3 minutes.

14. The method of claim 11 wherein the devising microwave-crisping sequence instructions further includes crisping the pizza crust with a crisping appliance selected from the group consisting of a stovetop pan on a stovetop and a toaster oven.

15. The method of claim 14 wherein the crisping step using a stovetop pan on a stovetop further includes crisping for a time period selected from the group consisting of a range of about 30 to about 180 seconds and a range of about 30 to about 90 seconds.

16. The method of claim 11 further comprising providing a planar transfer substrate and instructing to use the planar transfer substrate to transfer the hot pizza resulting from heating the frozen pizza crust and layered toppings in a microwave oven from the microwave oven to the crisping appliance.

17. The method of claim 16 wherein the step of providing a planar transfer substrate includes providing a grasping adaptation on the transfer device selected from the group consisting of (1) a tab extending co-planar from a peripheral edge, (2) a handle extending above the transfer device, (3) an elongated tab pivotally connected adjacent a peripheral edge of the transfer substrate where the elongated tab pivots between a stored position and a grasping position, and (4) a transverse side extending from a portion of the peripheral edge of the transfer device.

18. The method of claim 16 wherein the step of providing a planar transfer substrate includes selecting a planar transfer substrate made from a material consisting of plastic, paper, foil-coated paper, and combinations thereof.

19. A method for rapidly preparing frozen pizza for consumption, the method comprising:
obtaining a frozen pizza preparation package that is a container comprising:
a frozen prebaked pizza crust;
a pizza topping component having one or more toppings;
layering instructions for a consumer to layer the pizza topping component upon the frozen prebaked pizza crust;
a transfer substrate; and
microwave-crisping sequence instructions that instruct positioning the frozen prebaked pizza crust with topping thereon upon a transfer substrate and into a microwave oven, heating the pizza, and using the transfer substrate to transfer the microwave-heated pizza to a crisping appliance, and using the crisping appliance to crisp the crust; and
following the layering instructions and microwave-crisping sequence instructions.
